(19) United States
(12) Patent Application Publication
(10) Pub. No.: US 2026/0228674 A1
(43) Pub. Date: Aug. 6, 2026

(54) A METHOD AND A SYSTEM FOR AUTOMATICALLY MANAGING IN REAL-TIME A TOTAL STABILITY TIME BUDGET PROFILE ASSIGNED TO A PRODUCT

(71) Applicant: CONTROLANT HF., Kopavogur (IS)

(72) Inventors: Gisli HERJOLFSSON, Kopavogur (IS); Erlingur BRYNJULFSSON, Kopavogur (IS)

(21) Appl. No.: 19/128,692

(22) PCT Filed: Nov. 17, 2023
(86) PCT No.: PCT/EP2023/082230

§ 371 Date: May 9, 2025

(30) Foreign Application Priority Data
Nov. 18, 2022 (EP) 22208415.4

(51) Int. Cl. G06Q 10/0832; G06K 19/06; G06K 19/07; G06Q 10/0833

(52) U.S. Cl. CPC G06Q 10/0832; G06K 19/06037; G06K 19/0723; G06Q 10/0833

(57) ABSTRACT

A method is for automatically managing, in real-time, a total stability time budget profile assigned to a product during its transportation or storage in a supply chain. This supply chain includes two or more different transport legs, with a selection made for a given transport leg from those various legs.

### FIELD OF THE INVENTION

The present invention relates to a method and a system for automatically managing in real-time the total stability time budget profile assigned to a product.

### BACKGROUND OF THE INVENTION

Most if not all products that are used or consumed by people are associated with a stability period which may also be referred to as shelf life. Shelf life is dependent on product characteristics and is determined by product experts, commonly based on stability tests which are well defined experimental protocols.

For pharmaceutical products as an example, storage conditions are amongst others dependent on temperature, where the pharmaceutical products may have different preferred storage conditions, such as from 2-10° C., or 10-20° C., or below 0° C.

One of the challenges that pharmaceutical companies are dealing with today is the transport of pharmaceutical products from the manufacturing facilities to an end destination in the supply chains, which may be points of consumption such as hospitals or directly to patients.

The term stability time budget profile is commonly used in relation to the transport of pharmaceutical products through multiple transport legs in the supply chain. The stability time budget profile is determined through numerous types of stability studies, where a stability profile for each product is established. The stability time budget profile combines relevant information from temperature studies with available data from the stability testing to determine the amount of time a product can spend out of its labelled storage conditions without risk to its quality, safety, or efficacy. As the product moves through multiple transport legs in the supply chain, the stability time budget profile is used to determine whether at the end of the supply chain it's safe to be consumed, or not.

FIG. 1 illustrates an example of transporting a pharmaceutical product 100 in a supply chain, where in this example the supply chain consists of three transport legs, where the first transport leg 105 is the primary distribution and starts at a manufacturing (or packaging) site 101, the second transport leg 106 is the secondary distribution and the last transport leg 107 is the last mile distribution, where the primary and secondary distributions are e.g. separated at a regional distribution site 102, and the secondary and last mile distribution is separated at local market distribution 103.

Assuming the pharmaceutical product 100 has a total stability time budget profile of 300 hours, then as of today this time is divided into these three transport legs 105-107, which may be evenly divided in between them meaning that each transport leg has 100 hours of stability time budget.

As depicted here, the remaining stability time budget 108 after the first transport leg 105 is 100 hours since no deviation in the temperature occurred. Product 100 may thus be released to the second transport leg.

During the transport in the second transport leg 106, some temperature deviations occurs but still the remaining stability time budget profile 109 for the pharmaceutical product 100 is in surplus i.e. positive. Again, product 100 may be released to the third transport leg because the stability time budget profile is in surplus I.e. positive.

Additionally, after the end of the last transport leg i.e. the last mile 107, and due to the deviation that occurred, the remaining stability time budget 110 for the last leg is negative, e.g., the deviation was 105 hours.

In such scenarios, it is not possible to release the pharmaceutical product 100 and give it to a patient 104.

Therefore, a manual data accumulation process where emails, phone calls, and finding the right person to contact, must be done retroactively for all previous transport legs to evaluate if the overall stability time budget for the whole supply chain is positive or not.

Different distribution centers use different approaches to store this data, it may be manually stored in a paper form but not electronically, in pdf form, and in different data storage systems.

Moreover, the number of transport legs is commonly greater than three, e.g. 10-20, meaning that this manual data accumulation process can take up to several weeks. During this time, the pharmaceutical product may not be released.

Further complications may arise when the product is split up between shipments, e.g. boxes that belonged to a single shipment A will end up in separate shipments e.g. B and C, which can be further split up into separate shipments. Hence, the visibility of data such as the position, the stability budgets for shipments B and C as an example becomes very limited, and to some extents are based on estimations.

### SUMMARY OF THE INVENTION

It is an object of the invention to provide a fully automated solution to enhance the visibility of such products and enable full trackability of stability time budget profile in real-time throughout the supply chain, irrespective of the number of transport legs, and irrespective of whether larger product entities (bulk) are split into smaller product entities during the supply chain.

In general, the invention preferably seeks to mitigate, alleviate or eliminate one or more of the above-mentioned disadvantages of the prior art singly or in any combination. In particular, it may be seen as an object of the embodiments of the present invention to provide a method and a system that solves the above-mentioned problems, or other problems.

To better address one or more of these concerns, in a first aspect of the invention a method is provided of automatically managing in real-time a total stability time budget profile assigned to a product while the product is being transported or stored in a supply chain, where the supply chain comprises two or more different transport legs, the method comprises:
generating a shipment order for the product, where the shipment order comprises a unique shipment identifier (ID) for uniquely identifying the product,
associating a wireless logger device to the product, where the logger device comprises a temperature sensor, a memory, a power source, a transmitter and a processor for managing the temperature sensor, the memory and the transmitter,
regularly measuring, by the temperature sensor, the temperature of the product,
storing the measured temperature data in the memory of the logger device,
transmitting, by the transmitter, the stored measured temperature data to an external control computer together with data indicating the geographical location of the product while the product is being transported or stored in the supply chain,
determining, by the external control computer, if the measured temperature deviates from at least one pre-defined temperature value,
adding together, in case of a deviation from at least one pre-defined temperature value, the durations of time where the temperature deviated from the at least one pre-defined temperature value,
using the added deviation time as an input parameter in determining a remaining stability time budget profile assigned to the product, and
utilizing the remaining stability time budget profile as an input parameter in deciding on whether to release the product to a subsequent transport leg, where in case the product is to be released,
   cascading the remaining stability time budget profile over to the subsequent transport leg together with the unique shipment ID,
   wherein the method further comprises the steps of:
uniquely identifying the logger device with a unique logger device identifier (ID),
pairing the unique logger device ID with the unique shipment ID,
transmitting the paired unique logger device ID and the unique shipment ID to the external control computer where the paired logger device ID and the shipment unit ID are stored,
   wherein while the product is being transported or stored in the supply chain the logger device is further configured to, in addition to the regularly transmitted data indicating the geographical location of the product and the measured temperature data, transmit the logger device ID to the external control computer.

Accordingly, by cascading (may also be understood as transferring) the remaining stability time budget profile over to the subsequent transport leg together with the unique shipment ID it is possible to track in real time the status of the stability time budget profile for the product across different transport legs including primary, secondary, and last mile transport legs, which enables an automatic and instant release of the product from one transport leg to the next (or within few seconds or minutes), instead of days or weeks.

The logger device may be in a form of a label e.g. an IoT label, or a “smart-label”, bendable label or bendable logger device, where the power source may be based on an ultra-thin flexible battery, e.g. a ZincPoly solid-state battery, and where the thickness of the wireless label like logger device may be within the millimeter range. The logger device is preferably associated with the product by placing it into the packaging material containing the product, where the measured data is regularly, e.g. once every hour, transmitted to the external control computer that receives and processes the data.

The temperature measuring may additionally be performed by the transport means that transports the product e.g. containers, trucks, or within warehouses, where in warehouses, the product may be kept there until it starts with the next transport leg.

The steps of pairing the unique logger device ID with the unique shipment ID and transmitting the paired unique logger device ID and the unique shipment ID to the external control computer may be done prior to starting the transport in the supply chain, e.g. at the packaging facility.

In an embodiment, the step of pairing the unique logger device ID with the unique shipment ID comprises:
scanning the unique shipment ID, and
storing the unique shipment ID in the memory of the wireless logger device.

The step of storing may in one embodiment be performed by using a Radio Frequency Identification (RFID) device that receives the scanned unique shipment ID and interacts with the memory of the wireless logger device resulting in said storing.

The unique shipment ID comprises in one embodiment a barcode or a Quick Response (QR) code comprising at least one of a: serialization identifier, Product identifier (GTIN), expiration date identifier and/or Batch/Lot number identifier. The QR code may be placed on an outer side of a packaging material, e.g. printed or via adhesive material, containing the product and where the wireless logger device is placed into the packaging material, i.e. is physically separated from the unique shipment ID.

With this pairing between the logger device ID and the unique product ID in place the external control computer can extract the paired shipment ID information based on the received logger device ID and output information such as the geographical location of the shipment ID, and the stability budget of the product having associated the unique product ID in real time to a third party. The third party may as an example be the owner of the product and/or the logistic provider.

The product may be on a consumer packing level (e.g. a package with a single medicine), or a box level packing (e.g. multiple consumer packages each containing a single medicine) as an example.

Accordingly, such a “unit pairing” enables full tracking down to the “unit level” when multiple products are initially transported within the supply chain as a larger package or a bulk, e.g. multiple products placed in a box, and boxes on a pallet, where this larger package is later on split into smaller packaging units in a (e.g. at distribution centers) and down into unit level packages.

Due to the pairing of the logger device ID and the unique shipment ID, the external control computer, via the received logger device ID, contains necessary data to link the received positional data for each individual logger device to the characteristic information of the product in the individual shipment units via the unique shipment ID and output information indicating the geographical location of the product having he associated shipment ID and its stability budget to a third party. Thus, a full visibility of the products' geographical location and stability budget data is provided for each individual product throughout the whole supply chain where multiple transport legs are present.

In an embodiment, the transmitted data indicating the geographical location of the product may be estimated via cellular triangulation to accurately determine the location of the product, or simply the GPS (Global Positioning Satellite) data of the transport means may as an example be utilized to determine the location of the product.

The product may be any type of sensitive product, such as, but not limited to, any type of food, beverage, or pharmaceutical product.

In an embodiment, the step of determining the remaining stability time budget profile assigned to a product comprises determining the remaining total stability time budget profile assigned to the product, and where the step of cascading the stability time budget profile for each individual product comprises cascading the remaining total stability time budget profile of the previous transport leg over to the subsequent transport leg. The fact that the logger device ID is also cascaded provides continuous track of each individual product via said pairing.

In an embodiment, the at least one pre-defined temperature value for the measured environmental related parameter comprises an upper temperature value and a lower temperature value, where the upper and lower temperature values define a reference temperature range, where a deviation from the at least one pre-defined temperature range is when the measured temperature is above the upper temperature value and/or below the lower temperature value of the reference temperature range. Accordingly, the stability profile for the product may as an example be 2° C.-8° C. which is the reference temperature range meaning that in this temperature range the stability time budget profile remains the same, but a temperature deviation above 8° C. or below 2° C. will cause a decrease in the stability time budget profile. The term deviation in this context may also be understood as a temperature excursion, or simply excursion.

In an embodiment, the at least one pre-defined temperature value further defines one or more secondary temperature range(s) above the upper reference temperature value and/or below the lower reference temperature value, where each of the one or more secondary temperature range(s) are provided with a maximum allowed time for the temperature to deviate from the reference temperature range,

wherein the method further comprises subtracting the duration of time where the measured temperature deviates from the reference temperature range from the allowed time for the secondary temperature range(s) where the deviation occurred, and where the step on deciding whether the release of the product to the subsequent transport leg requires that the remaining allowed time is equal or larger than zero.

In an embodiment, the step of using the added deviation time as an input parameter in determining a remaining stability time budget profile includes determining a remaining total stability time budget profile assigned to the product.

As an example, assuming that the product is a pharmaceutical product, and the stability time budget profile may be 2-10° C. This is the may understood as the reference temperature range.

A first-subrange of the secondary range may be where the pharmaceutical product is +10° C.-+20°C. and 0° C.-+2°C. and the second-subrange of the secondary range is +20° C.-+30°C. and −5° C.-0° C.

Assuming the number of transport legs are 3, which may be referred to as a primary transport distribution, a secondary transport leg, and a last mile transport leg. The primary transport distribution may be where the product is transported by one or several transport means from the manufacturing facility to a regional distribution center. The secondary transport leg may be the transport of the product from the regional distribution center to the local market distribution center. The last mile may be the transport of the product from the local market distribution center to pharmacies, hospitals, or directly to the patient.

The first-subrange of the secondary range has a remaining allowed total time of 30 h and the second-subrange of the secondary range has a remaining allowed total time of 12 h.

Furthermore, above +30° C. and below −5° C. there is zero allowable time, meaning that the product is deemed to be unusable if the temperature of the product becomes higher/lower than +30 C./−5° C.

These maximum allowable times mean that during the time window from where the product has been produced and/or leaves the manufacturing facility until it reaches it's final destination, the temperature deviation of the product from the reference temperature range, may not exceed these maximum allowable time limits, e.g. if the total deviation in the second-subrange of the secondary range is more than 12 h, the product is deemed to be unusable.

Assume now that no deviation from the at least one pre-defined temperature range (excursion) occurs during the first transport leg, i.e. the temperature of the pharmaceutical product is within the temperature range 2-10° C., the control computer cascades these 30 hours and 12 hours of stability time budget from said ranges to the second transport leg together with the unique shipment ID as already mentioned.

Continuing with the example, in the second transport leg, the temperature goes from 10° C. and exceeds 20° C. in 1 hour and remains for 1 h in the second-subrange of the secondary range and for further 0.5 h in the first-subrange of the secondary range until it reaches the reference temperature range 2-10° C. One way of calculating the reduction in the stability time budget profile might then be determined in the following way: 1 h (first-subrange) +1 h (second-subrange) +1 h (first-subrange)+0.5 h (first-subrange)=3.5 h. Thus, the resulting remaining total stability time budget for the first-subrange of the secondary range is thus 30 h−2.5=27.5 h and the remaining stability time budget for the second-subrange of the secondary range is 12−1=11 h.

The total stability time budget profile is updated in real time meaning that if the frequency is 1 hour for the transmission of the temperature measurements and shipment unit ID to the external control computer then the remaining stability time budget profile is being updated every hour, thus making the total remaining stability time budget profile always available.

Based on the above information, the fact that the stability time budget profile and the remaining maximum allowable time limits are being monitored in real time, and the releasing requirement is fulfilled meaning that the above-mentioned stability time budgets throughout the supply chain are still in plus, makes it possible to instantly release the pharmaceutical product to the next transport leg or directly to the patient.

In an embodiment, if the deviation includes deviating from the upper reference value and/or the lower reference value, or vice versa, the step of adding together the deviations, includes adding an additional pre-defined additional weight on the time where the environmental related parameter deviates from at least one pre-defined reference value. The upper reference value and the lower reference value may as an example be said 2° C. and 10° C. Wherein this is relevant for some products, such as sensitive products, a cycle where e.g. the temperature exceeds the upper limit and goes under the lower limit can have an additional effect meaning that the additional duration on the original deviation time is highly relevant. Thus, assuming the time above the upper limit is 1 h and 2 h below the lower temperature limit, i.e. 3 h total time, the additional duration might be an extra 20% to the 3 h deviation time, meaning that the total deviation time would be calculated as 3.6 h.

In an embodiment, at least one pre-defined temperature value comprises a maximum temperature value and/or a minimum temperature value, where if the deviation exceeds the maximum temperature value or is below the minimum temperature value the product is deemed to be unusable.

In an embodiment, the step of using the added deviation time between the ranges as an input parameter in determining a remaining stability time budget profile includes determining a remaining total stability time budget profile for the supply chain assigned to the product, where the step of deciding on whether release the product to the subsequent transport leg is based on that the remaining total stability time budget profile for the supply chain is greater than zero. Accordingly, if the total stability time budget profile is zero, the product is deemed to be unusable.

In an embodiment, the method further comprises dividing the total stability time budget profile on the two or more different transport legs, wherein the step of cascading the remaining stability time budget profile over to the subsequent transport leg comprises adding the remaining stability time budget profile of the previous transport leg to a stability time budget profile assigned to the subsequent transport leg. Each of the two or more different transport legs may in an embodiment be assigned a risk factor indicating the risk of deviation of the temperature from the at least one pre-defined reference temperature value, wherein dividing the total stability time budget profile between the transport legs is dependent on the risk factor assigned to the two or more different transport legs.

In an embodiment, the method further comprises regularly measuring one or more additional environment related parameters, in addition to the temperature of the product, selected from one or more of the:
air pressure around the product,
humidity of the product
tilting angle of the product,
shock the product is affected by,

wherein managing in real-time the total stability time budget profile assigned to the product further includes monitoring the stability time budget profile for one or more of said environmental related parameters.

The humidity may as an example be of relevance when considering the condition of the packaging of the products, especially if the packaging is made of paper. The shock may as an example be of relevance if the packaging is made of glass, where too many shocks may result in the packaging breaking.

In an embodiment, the step of tracking the product from one transport leg to a next transport leg is done via the unique shipment ID of the product. The unique shipment ID may as an example include any type of serial number, thus providing a simple solution to track the product through different transport legs.

In an embodiment, the method further comprises:

generating a bulk shipment order comprising a unique bulk shipment ID, where the bulk shipment order comprises multiple of said products,
wherein the method further comprises,
separating at least some of the products from the bulk shipment between two adjacent transport legs, and
tracking the separated products via the unique product ID of each individual product in the subsequent transport leg(s),
wherein the step of cascading the remaining stability time budget profile further includes cascading the remaining stability time budget profile onwards for the unique sub-product ID.

As an example, the bulk product may be two pallets that are transported in a container that may be uniquely identified as ID123 e.g. via a serial number of any type or a code. When generating the bulk shipment order, an ID tree is generated for all units down to a box level or a box consumer level. The highest level of this ID tree is ID123.

Accordingly, in the primary distribution, the bulk product is transported as a single product, where the stability time budget profile is monitored in real time, where e.g. a logger device in the container regularly transmits the temperature data, the unique logger device ID123, the position of the container in real time.

When the container arrives at a regional distribution site, it is opened, and the two pallets are removed from the container. At this moment, the logger device is removed from the container and returned. The stability budget of products in the container, i.e. as registered via the logger device associated to the container, will be transferred to the two pallets.

The second level in the ID tree is the ID of said pallets, ID456 and ID789, where logger devices associated with ID456 and ID789 transmit data relating to the shipment order of the pallets, together with the logger device ID, the position of the pallets, and the real-time total stability time budget profile is updated in real time.

This process is then repeated when the pallets are broken down into lower packing level e.g. product, where the stability budget for the two pallets is transferred to the products on the individual pallets. Now, the ID tree is moved to a third level, which may be the product level, where via the logger devices ID associated to the products, the position, and the real-time total stability time budget profile etc. may be monitored in real time as discussed previously. Thus, if the two pallets contain 60 products, e.g. boxes, each box may be tracked to the end consumer, which may be a: patient, pharmacy, or hospital.

Upon arrival at the end stop the stability time budget profile is available and the decision of whether the products may be released (or not be released) may be taken instantly. The fact that each individual product is tracked in real time may result in that some products may not be released because the stability time budget over the supply chain is negative, whereas other stability time profiles for other products may be positive and therefore these product may be released almost immediately.

In a second aspect of the invention, a system is provided for automatically managing in real-time a total stability time budget profile assigned to a product while the product is being transported or stored in a supply chain, where the supply chain comprises two or more different transport legs, the system comprising:

a computer device for receiving a shipment order for the product, where the shipment order comprises a unique shipment identifier (ID) for uniquely identifying the product,
an external control computer system,
a wireless logger device configured to be associated to the product, where the logger device comprises:

a temperature sensor for measuring the temperature of the product,

a memory for storing the measured temperature data,

a transmitter for transmitting the stored measured temperature data to the external control computer together with the unique shipment ID of the product while the product is being transported or stored in the supply chain, where the external control computer is configured to:
determine if the measured temperature deviates from at least one pre-defined temperature value,
add together, in case of a deviation from the at least one pre-defined temperature value, the time where the temperature deviates from the at least one pre-defined temperature value,
use the added deviation time as an input parameter in determining a remaining stability time budget profile assigned to the product,
utilize the remaining stability time budget profile as an input parameter in deciding on whether to release the product to a subsequent transport leg, where in case the product is to be released;
cascading the remaining stability time budget profile over to the subsequent transport leg together with the unique shipment ID,
   wherein the system further comprises:
   an identifier for uniquely identifying the wireless logger device with a unique logger device identifier (ID),
   a pairing device for pairing the unique logger device ID with the unique shipment ID,
   where the transmitter is further configured to:
   transmit the paired unique logger device ID and the unique shipment ID to the external control computer system where the paired logger device ID and the shipment unit ID is stored,
   where the transmitter is further configured to, while the product is being transported or stored in the supply chain,
   transmit on a regular basis the positional data of the logger device, the measured temperature data, and the logger device ID to the external control computer.

Accordingly, a system is provided that automates the product release process at the end of the shipment based on measurements and data captured during the shipment.

In general, the various aspects of the invention may be combined and coupled in any way possible within the scope of the invention. These and other aspects, features, and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a prior art scenario of how the stability time budget profile for a product is monitored,

FIG. 2 shows a flowchart of an embodiment of a method according to the present invention,

FIG. 3 illustrates graphically an example of transporting a pharmaceutical product in a supply chain as discussed in relation to FIG. 2,

FIG. 4 illustrates the same simplified supply chain as shown in FIG. 3,

FIG. 5 shows the supply chain in FIG. 3, but where the stability time budget profile has several ranges, and

FIG. 6 shows an example of how to determine, by the external control computer, the time where the temperature deviates from a reference temperature range.

### DESCRIPTION OF EMBODIMENTS

FIG. 2 illustrates a flowchart of an embodiment of a method according to the present invention for automatically managing in real-time a total stability time budget profile assigned to a product while the product is being transported or stored in a supply chain, where the supply chain comprises two or more different transport legs.

The product may be any type of pharmaceutical product (any type of medicine and the like), a food product such as fish fillet, beef, pork, a beverage, and/or any product consumed or used by a person.

In the pharma industry, the term stability time budget profile is determined through numerous types of stability studies, where a stability profile for each product is established. The stability time budget combines relevant information from temperature studies with available data from the stability testing to determine the amount of time a product can spend out of its labelled storage conditions without risk to its quality, safety or efficacy.

As the product moves through multiple transport legs in the supply chain, the stability time budget profile is used to determine whether at the end of the supply chain it's safe to be consumed, or not.

For simplicity, in the following, it will be assumed that the product is a pharmaceutical product, and that the environment related parameter is the temperature of the product or around the product.

In a first step (S1) 201, for a given transport leg selected from two or more different transport legs, a shipment order is generated for the pharmaceutical product, where the shipment order comprises a unique shipment identifier (ID) for uniquely identifying the pharmaceutical product. The unique shipment ID may be a serial number or any type of smart code, such as a QR code.

In a second step (S2) 202, a wireless logger device is associated to the product, e.g. placed into a box containing the product, where the logger device comprises a temperature sensor, a memory, a transmitter and a processor for managing the temperature sensor, the memory and the transmitter.

In a third step (S3) 203, the temperature of the pharmaceutical product is measured on a regular basis via the temperature sensor of the logger device, e.g. every 10 minutes, and stored in the memory of the logger device. The measured temperature is measured by the temperature sensor of the logger device into said box, or the temperature may be the ambient temperature for the pharmaceutical product within the box.

In a fourth step (S4) 204, the measured temperature is transmitted by the transmitter to an external control computer together with the unique logger device ID via e.g. cellular network on a regular bases, e.g. every hour, every 30 min, every 2 hours etc .. The external control computer may also be understood as any type of a cloud platform solutions, where the data is processed.

In a fifth step (S5) 205, the external control computer processes the received data and amongst others determines if the measured temperature deviates from at least one pre-defined temperature value. The at least one temperature reference value may comprise an upper reference temperature value and a lower reference temperature value, where the upper and lower reference temperature values define a reference temperature range, where the deviation from the at least one pre-defined reference temperature value is where the measured environmental related parameter is above the upper reference temperature value and/or below the lower reference temperature value.

In an embodiment, the at least one pre-defined temperature value may also be a single temperature value and where the deviation from the at least one pre-defined temperature value is where the measured temperature is above or below the single temperature value.

In a sixth step (S6) 206, in case of a deviation from the at least one pre-defined temperature value, the time is added together where the temperature deviates from the at least one pre-defined temperature value. The term deviates may also be understood as temperature excursion.

In a seventh step (S7) 207, the added deviation time is used as input parameter in determining a remaining stability time budget profile assigned to the product.

In an eighth step (S8) 208, the remaining stability time budget profile is utilized as an input parameter in deciding on whether to release the product to a subsequent transport leg. As an example: a situation may occur where after the primary distribution, if the stability time budget for that transport leg is negative, a situation may be that the pharmaceutical product may not be released to the next transport leg (secondary distribution).

In a nineth step (S9) 209, in case the product is released to the next transport leg, the remaining stability time budget profile from the first transport leg is cascaded over to the subsequent transport leg together with the unique product ID. By cascading the unique product ID in that way, the product may be clearly identified in the subsequent transport leg.

A tenth step (S10) includes uniquely identifying the wireless logger device with a unique logger device identifier (ID).

An eleventh step (S11) includes pairing the unique logger device ID with the unique shipment ID.

A twelfth step (S12) includes transmitting the paired unique logger device ID and the unique shipment ID to the external control computer system where the paired logger device ID and the shipment unit ID is stored.

Steps S10-S12 are preferably done at the beginning and before the start of transporting the product in the supply chain. This may as an example be done at a packaging site of the product.

Subsequent to steps S10-S12 and while the product is being transported or stored in the supply chain, the logger device is further configured to, in addition to the regularly transmitted data indicating the geographical location of the product and measured temperature data, transmit the logger device ID to the external control computer. In that way, the external control computer can identify what product it is in real time.

In an embodiment, the step of determining the remaining stability time budget profile assigned to the pharmaceutical product comprises determining the remaining total stability time budget assigned to the pharmaceutical product, and where the step of cascading the stability time budget profile comprises cascading the remaining total stability time budget profile over to the subsequent transport leg. In another embodiment, the total stability time budget profile for the pharmaceutical product may be divided between the different transport legs, wherein the step of cascading the remaining stability time budget profile over to the subsequent transport leg comprises adding the remaining stability time budget profile of the previous transport leg to a stability time budget profile assigned to the subsequent transport leg.

As will be discussed in more details later, there may be one or more secondary temperature ranges, where the ranges have assigned maximum allowable time limits for the temperature to deviate from the reference temperature range, where the maximum allowable time limits become less the further the one or more secondary range(s) are from the reference temperature range. If the deviation from the reference temperature exceeds this maximum allowable time limit, the product is deemed to be unusable.

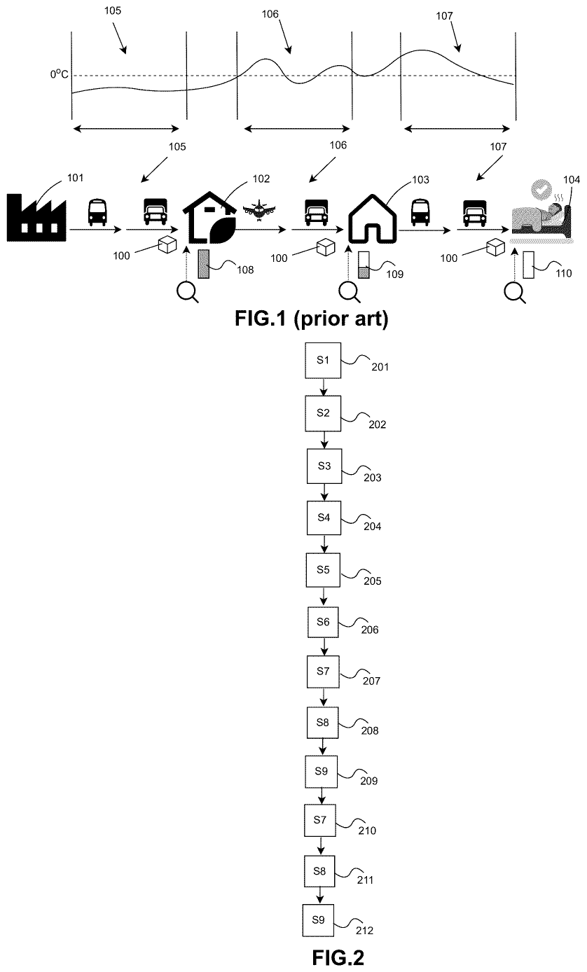

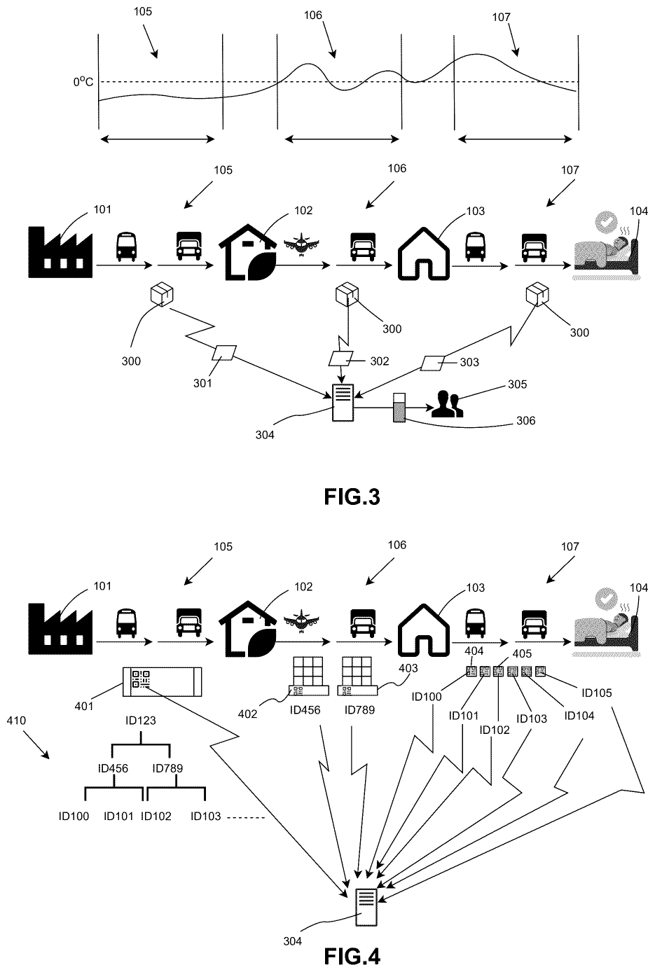

FIG. 3 illustrates graphically an example of transporting a pharmaceutical product 300 in a supply chain as discussed in relation to FIG. 2, where the supply chain is similar as the one discussed in relation to the prior art FIG. 1 having three transport legs, where the first transport leg 105 is primary distribution and starts at a manufacturing (or packaging) site 101, the second transport leg 106 is secondary distribution and the last transport leg 107 is last mile distribution, where the primary and secondary distributions are e.g. separated at regional distribution site 102, and the second and the last mile distribution is separated at local market distribution 103.

Assuming the pharmaceutical product 100 has a total stability time budget of 300 hours, and as depicted here the at least one pre-defined temperature value is a single temperature value indicated by the dotted line, and this may be 0° C. (or obviously any value) where the temperature should be below this value (could of course be vice versa).

The product in the primary distribution 105 may be associated with a logger device which on a regular basis, e.g. every hour, transmits data 301 to an external control computer system 304, the data includes the temperature of the pharmaceutical product 100, the unique logger device ID and the position of the product. The external control computer system 304 monitors in real time if there is a deviation or not as discussed in relation to FIG. 1 and FIG. 2 and can identify in real time what product it is.

As depicted here, there is no deviation from the single reference temperature value (0° C.), i.e. no deviation occurred in the primary distribution leg meaning that the temperature was kept below 0° C. during the entire primary transport leg. In the regional distribution site 102 the temperature is preferably measured while the pharmaceutical product is in there, in some cases, products may be kept there for several days. With the fact that the total stability time budget profile is in surplus i.e. positive, the pharmaceutical product 300 may be released to the next transport leg i.e. the secondary distribution 106.

In the second transport leg 106 (secondary distribution) the transmitted data 302 is processed in real time and the stability time budget profile 306 is updated accordingly in real time and the data is accessible to an operator of the supply chain and/or the owner 305 of the pharmaceutical product 300. It should be noted that the temperature data may also be provided by the transport means, warehouses etc ..

With the fact that at the end of the secondary distribution the stability time budget profile is in surplus i.e. positive the pharmaceutical product 300 may be released immediately to the last transport leg 107 (last mile distribution).

As illustrated here, there is a significant deviation from the reference temperature value in 106-107 but due to the reason that the total stability time budget profile 306 is updated in real time at the end of the last mile distribution, the pharmaceutical product 300 may be released immediately.

As discussed in relation to FIG. 1, the stability time budget profile for the last transport leg exceeds the stability time budget profile assigned to the last transport leg, this would cause several weeks of delay if the total stability budget was not available, and mainly because only the resulting stability time budget profile for the last mile distribution is available. However, the fact that the stability time budget profile is available for the whole supply chain in real time, this is no longer an issue because in total the stability time budge profile is in plus.

In the example discussed here, the total stability time budget profile is being monitored in real time, but in another embodiment, the total stability time budget profile might just as well be divided onto the three transport legs, where the stability time budget profile for the different legs might as well be provided in real time, where at the end of each transport leg the remaining stability time budget profile would be cascaded to the next transport leg.

FIG. 4 illustrates the same simplified supply chain as shown in FIG. 3 having said three transport legs 105-107, starting with bulk product 401 that is later one divided into smaller bulk products in different transport legs, ending with the products as the smallest entity.

The bulk product contains multiples of said product that are arranged on two pallets as shown here that are transported in a container 401 that may be uniquely identified as ID123 e.g. via a serial number of any type or a code. When generating the shipment order, an ID tree 410 is generated for all bulk units (container, pallet etc ..) down to a product level, where the highest level of this ID tree is ID123.

The pairing between the logger device associated with each product and the unique product ID are performed as discussed previously, where the unique paired ID's is stored at an external computer 304.

Accordingly, in the primary distribution 105, the bulk product is a single product as shown in FIG. 3, where the stability time budget profile is monitored in real time as discussed previously in relation to FIGS. 2 and 3, where e.g. a logger device in the container regularly transmits temperature data, the unique logger device ID123 and the position of the container to an external control computer.

When container 401 arrives at regional distribution site 102, it is opened and the two pallets 402 and 403 are removed from the container. At this moment, the logger device is removed and returned.

The two pallets are uniquely identified via ID456 and ID789, where logger devices associated with ID456 and ID789 transmit data relating to the shipment order of the pallets, together with the logger device ID, the position, and the real-time total stability time budget profile.

At arrival at the local market distribution 103, the total stability time budget profiles for both the pallets 402 and 403 are displayed, where in case both the total stability time budget profiles are in surplus i.e. positive both pallets may be released to the last mile distribution. It should be noted that one of the pallets might not be released while the other pallet might be released.

At the local market distribution 103 the boxes, which may contain multiple of products, are removed from the pallets, where each individual box is uniquely identified via ID100-ID105 as shown in the ID tree 410. This process is then repeated when the boxes are dissolved into products (not shown here), where via the logger devices IDs i.e. ID′100-ID′105, each individual product may be identified in real time and information such as it's position and the real-time total stability time budget profile any also be identified in real time. Thus, if the two pallets contained 60 products, e.g. boxes, each box may be tracked to the end consumer, which may be a: patient, pharmacy or hospital 104.

The term box may in this embodiment also be understood as a product and be the smallest entity.

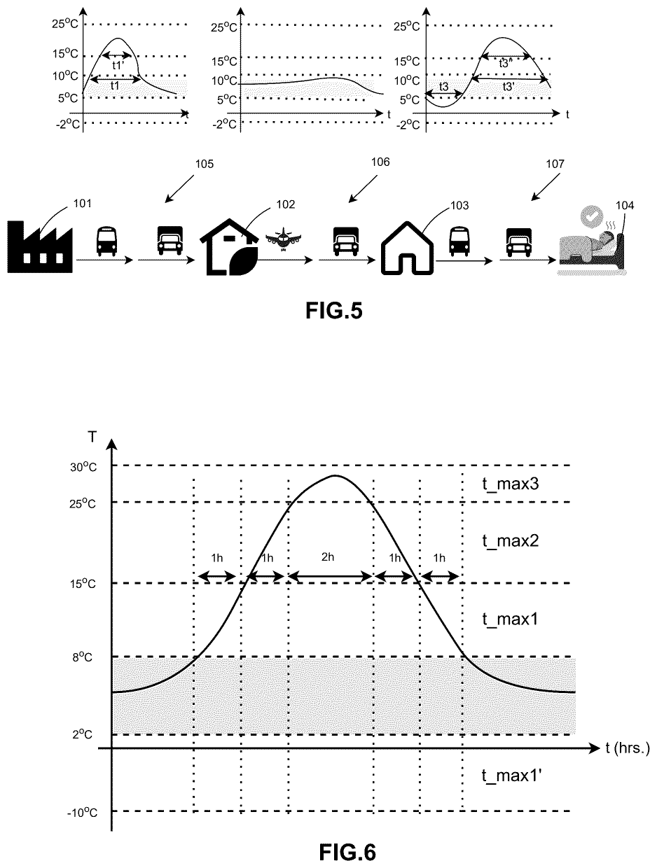

FIG. 5 shows the supply chain in FIG. 3, but where the stability time budget profile has several ranges, where the ranges may be presented in the following way:
Over 25°C: 0 hours
15° C.-+25° C.: 18 hours
10° C.-+15°C: 50 hours
0° C.-+5°C: 40 hours
- 2° C.-0° C.: 18 hours
Below −2° C.: 0 hours
Another setup of a stability time budget profile may also be the following:
Over 25° C.: 0 hours
Over 15° C.: 18 hours
Over 10° C.: 50 hours
Below 5° C.: 40 hours
Below 0° C.: 18 hours
Below −2° C.: 0 hours.

Accordingly, the reference temperature range is 5-10° C. and any temperature deviation outside of this range will reduce the stability time budget profile.

The first-subrange of the secondary range is where the pharmaceutical product is between +10° C.-+15° C. and 0° C.-+2° C. (not shown), second-subrange of the secondary range is when the pharmaceutical product is between +15° C.-+25° C. and 0° C.-−2° C.(not shown).

As illustrated here, during the first transport leg in FIG. 2, there is an deviation from the reference temperature range 5-10° C., over a period t1 and t1′. If t1 is 4 hours and t1′ is 2 hours, the stability budget for the range 10-15° C. is reduced by subtracting the hours of the deviation from the stability predefined 50 hours budget, hence the updated stability budget for this range becomes 46 hours. The same applies for the range 15-25° C. which becomes 18−2=16 hours.

In the secondary distribution 106 no deviation occurs whereas in the last mile distribution there are deviations t3, t3′ and t3″. Assuming t3 is 10 hours, t3′ is 20 hours and t3″ is 15 hours, the resulting stability budget for these ranges becomes 40−10=30 hours for the range 0-5° C., 46 −20=26 hours for the range 10-15° C., and 16−15=1 hours for the range 15-25° C. Thus, the product may be released.

FIG. 6 shows an example of how to determine, by the external control computer system, the time where the temperature deviates from a reference temperature range of e.g. 2-8° C., where the number of hours where the temperature between 8-15° C. is 6 h, between 15-25° C. is 4 h and between 25-30° C. is 2 h, i.e. the total deviation is 12 h.

Also, the criteria that the maximum allowable time limits in one or more secondary range(s) must be larger than the deviation in these ranges must be fulfilled, i.e. t_max 1—6 h>0, t_max2—4 h>0 and t_max3—2 h>0.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art of practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1.-18. (canceled).

19. A method of automatically managing in real-time a total stability time budget profile assigned to a product the product is being transported or stored in a supply chain, where the supply chain comprises two or more different transport legs, where for a given transport leg selected from the two or more different transport legs, the method comprises:
generating a shipment order for the product, where the shipment order comprises a unique shipment identifier for uniquely identifying the product,
associating a wireless logger device to the product, where the logger device comprises a temperature sensor, a memory, a transmitter and a processor for managing the temperature sensor, the memory and the transmitter,
regularly measuring, by the temperature sensor, the temperature of the product, storing the measured temperature data in the memory,
transmitting, by the transmitter, the stored measured temperature data to an external control computer together with data indicating the geographical location of the product while the product is being transported or stored in the supply chain,
determining, by the external control computer system, if the measured temperature deviates from at least one pre-defined temperature value,
adding together, in case of a deviation from the at least one pre-defined temperature value, the durations of time where the temperature deviated from the at least one pre-defined temperature value,
using the added deviation time as an input parameter in determining a remaining stability time budget profile assigned to the product, and
utilizing the remaining stability time budget profile as an input parameter in deciding on whether to release the product to a subsequent transport leg, where in case the product is to be released;
cascading the remaining stability time budget profile over to the subsequent transport leg together with the unique shipment ID,
wherein the method further comprises the steps of:
uniquely identifying the wireless logger device with a unique logger device identifier (ID),
pairing the unique logger device ID with the unique shipment ID,
transmitting the paired unique logger device ID and the unique shipment ID to the external control computer system where the paired logger device ID and the shipment unit ID are stored,
wherein, while the product is being transported or stored in the supply chain, the logger device is further configured to, in addition to the regularly transmitted data indicating the geographical location of the product and the measured temperature data, transmit the logger device ID to the external control computer.

20. The method according to claim 19, wherein the step of pairing the unique logger device ID with the unique shipment ID comprises:
scanning the unique shipment ID, and
storing the unique shipment ID in the memory of the wireless logger device.

21. The method according to claim 19, wherein the step of storing is performed by using a Radio Frequency Identification (RFID) device that receives the scanned unique shipment ID and interacts with the memory of the wireless logger device resulting in said storing.

22. The method according to claim 19, wherein the unique shipment ID comprises a barcode or a Quick Response (QR) code comprising at least one of a: serialization identifier, Product identifier (GTIN), expiration date identifier and/or Batch/Lot number identifier.

23. The method according to claim 19, wherein the QR code is placed on an outer side of a packaging material containing the product and where the wireless logger device is placed into the packaging material.

24. The method according to claim 19, wherein the external control computer is further configured to utilize the received logger device ID to extract the paired shipment ID and output information indicating the geographical location of the shipment ID and the stability budget of the product in real time to a third party.

25. The method according to claim 19, wherein the step of determining the remaining stability time budget profile assigned to a product comprises determining the remaining total stability time budget assigned to the product, and where the step of cascading the stability time budget profile comprises cascading the remaining total stability time budget profile of the previous transport leg over to the subsequent transport leg.

26. The method according to claim 19, wherein the at least one pre-defined temperature value may also be a single temperature value and where the deviation from the at least one pre-defined temperature value is where the measured temperature is above or below the single temperature value.

27. The method according to claim 19, wherein the at least one pre-defined temperature value for the measured environmental related parameter comprises an upper temperature value and a lower temperature value, where the upper and lower temperature values define a reference temperature range, where a deviation from the at least one pre-defined temperature range is when the measured temperature is above the upper temperature value and/or below the lower temperature value of the reference temperature range.

28. The method according to claim 27, wherein the at least one pre-defined temperature value further defines one or more secondary temperature range(s) above the upper reference temperature value and/or below the lower reference temperature value, where each of the one or more secondary temperature range(s) are provided with a maximum allowed time for the temperature to deviate from the reference temperature range,
wherein the method further comprises subtracting the duration of time where the measured temperature deviates from the reference temperature range from the allowed time for the secondary temperature range(s) where the deviation occurred, and where the step on deciding on the release of the product to the subsequent transport leg requires that the remaining allowed time is equal or larger than zero.

29. The method according to 27, wherein if the deviation includes deviating from the upper reference temperature value and/or the lower reference temperature value, or vice versa, the step of adding together the deviations, includes adding an additional time weight on the time where the temperature deviates from the reference temperature range.

30. The method according to claim 19, wherein the at least one pre-defined temperature value comprises a maximum temperature value and/or minimum temperature value, where if the deviation exceeds the maximum temperature value or is below the minimum temperature value the product is deemed to be unusable.

31. The method according to claim 26, wherein the step of using the added deviation time as an input parameter in determining a remaining stability time budget profile includes determining a remaining total stability time budget profile for the supply chain assigned to the product, where the step of deciding on whether to release the product to the subsequent transport leg is based on that the remaining total stability time budget profile for the supply chain is greater than zero.

32. The method according to claim 19, where the method further comprises dividing the total stability time budget profile on the two or more different transport legs, wherein the step of cascading the remaining stability time budget profile over to the subsequent transport leg comprises adding the remaining stability time budget profile to a stability time budget profile assigned to the subsequent transport leg.

33. The method according to claim 32, wherein each of the two or more different transport legs are assigned with a risk factor indicating the risk of deviation of the temperature from the at least one pre-defined reference temperature value,
wherein dividing the total stability time budget profile between the transport legs is dependent on the risk factor assigned to the two or more different transport legs.

34. The method according to claim 19, wherein the product comprises a pharmaceutical product.

35. The method according to claim 19, further comprising generating a bulk shipment order comprising a unique bulk shipment ID, where the bulk shipment order comprises multiple of said products
wherein the method further comprises,
separating at least some of the products from the bulk shipment between two adjacent transport legs, and
tracing the separated products via the unique product ID of each individual product in the subsequent transport leg(s),
wherein the step of cascading the remaining stability time budget profile further includes cascading the remaining stability time budget profile for the unique product ID.

36. A system for automatically managing in real-time a total stability time budget profile assigned to a product while the product is being transported or stored in a supply chain, where the supply chain comprises two or more different transport legs, the system comprising:
a computer device for receiving a shipment order for the product, where the shipment order comprises a unique shipment identifier (ID) for uniquely identifying the product, an external control computer system,
a wireless logger device configured to be associated to the product, where the logger device comprises:
a temperature sensor for measuring the temperature of the product,
a memory for storing the measured temperature data, an external control computer, a transmitter for transmitting the stored measured temperature data to the external control computer together with the unique shipment ID of the product while the product is being transported or stored in the supply chain, where the external control computer is configured to:
determine if the measured temperature deviates from at least one pre-defined temperature value,
add together, in case of a deviation from the at least one pre-defined temperature value, the time where the temperature deviates from the at least one pre-defined temperature value,
use the added deviation time as an input parameter in determining a remaining stability time budget profile assigned to the product, and
utilize the remaining stability time budget profile as an input parameter in deciding on whether to release the product to a subsequent transport leg, where in case the product is to be released;
cascading the remaining stability time budget profile over to the subsequent transport leg together with the unique shipment ID,
wherein the system further comprises:
an identifier for uniquely identifying the wireless logger device with a unique logger device identifier (ID),
a pairing device for pairing the unique logger device ID with the unique shipment ID, where the transmitter is further configured to:
transmit the paired unique logger device ID and the unique shipment ID to the external control computer system where the paired logger device ID and the shipment unit ID is stored,
where the transmitter is further configured to, while the product is being transported or stored in the supply chain:
transmit on a regular basis the positional data of the logger device, the stored temperature data and the logger device ID to the external control computer.
